(19) United States
(12) Patent Application Publication
(10) Pub. No.: US 2025/0171356 A1
(43) Pub. Date: May 29, 2025

(54) COCOA POD HUSK-CONTAINING HARDENING-RETARDER AND A METHOD FOR MAKING THE SAME

(71) Applicant: National Pingtung University of Science and Technology, Pingtung County (TW)

(72) Inventor: Chia-Jung TSAI, Pingtung County (TW)

(73) Assignee: National Pingtung University of Science and Technology, Pingtung County (TW)

(21) Appl. No.: 18/959,201

(22) Filed: Nov. 25, 2024

(30) Foreign Application Priority Data
Nov. 27, 2023 (TW) 112145781

(51) Int. Cl. C04B 24/00; C04B 103/24

(52) U.S. Cl. CPC C04B 24/001; C04B 2103/24

(57) ABSTRACT

A method for making the cocoa pod husk-containing hardening-retarder from cocoa pod husks includes: fragmenting cocoa pod husks into husk fragments; drying the husk fragments under a temperature that ranges from 95° C. to 105° C.; grinding the husk fragments which are dried into a soluble powder; mixing the soluble powder with water to form a liquid mixture, wherein the liquid mixture contains from 20% to 40% of the soluble powder by weight and 60% to 80% of water by weight, based on 100% of the liquid mixture by weight; and filtering the liquid mixture with a filter having a pore size that ranges from 5 microns to 20 microns to obtain the cocoa pod husk-containing hardening-retarder.

### CROSS-REFERENCE TO RELATED APPLICATION

This application claims priority to Taiwanese Invention Patent application Ser. No. 11/214,5781, filed on Nov. 27, 2023, and incorporated by reference herein in its entirety.

### FIELD

The disclosure relates to a method of making a hardening-retarder, and more particularly to a method of making cocoa pod husk-containing hardening-retarder for retarding hardening of cement and a cocoa pod husk-containing hardening-retarder made via the method.

### BACKGROUND

Cocoa is a popular agricultural product that has experienced rapid commercial development and expansion in recent years. Although the most popular and well known cocoa product is chocolate, the cocoa plant is very versatile and has a wide variety of uses. Cocoa may be made into drinks such as hot chocolate, processed into chocolate noodles, or made into new products such as cocoa soap which is made from the cocoa butter obtained from cocoa beans. However, the above described products derived from the cocoa plant are made using only the cocoa beans and the cocoa pulp of cocoa pods and their manufacture does not involve the use of the cocoa pod husk from which the cocoa beans and the cocoa pulp are extracted. Up until now, in the conventional processing process, cocoa beans and cocoa pulp are removed from the cocoa pods and the cocoa pod husks are usually treated as agricultural waste and discarded as there is no effective way to utilize the discarded cocoa pod husks.

### SUMMARY

Therefore, an object of the disclosure is to provide a method for making a cocoa pod husk-containing hardening-retarder from cocoa pod husks and a cocoa pod husk-containing hardening-retarder made via the above method that can alleviate at least one of the drawbacks of the prior art.

According to the a first aspect of the disclosure, the method for making the cocoa-pod-husk-containing hardening-retarder from cocoa pod husks includes: fragmenting cocoa pod husks into husk fragments; drying the husk fragments under a temperature that ranges from 95° C. to 105° C.; grinding the husk fragments which have been dried into a soluble powder; mixing the soluble powder with water to form a liquid mixture, wherein the liquid mixture contains from 20% to 40% of the soluble powder by weight and 60% to 80% of water by weight, based on 100% of the liquid mixture by weight; and filtering the liquid mixture with a filter having a pore size that ranges from 5 microns to 20 microns to obtain the cocoa pod husk-containing hardening-retarder.

According to a second aspect of the disclosure the cocoa pod husk-containing hardening-retarder is made according to the method described above.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an embodiment of a method of making a cocoa pod husk-containing hardening-retarder from cocoa pod husks according to the present disclosure.

FIG. 2 is a chart illustrating an initial setting time and a final setting time for Sample (A) and Sample (B).

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

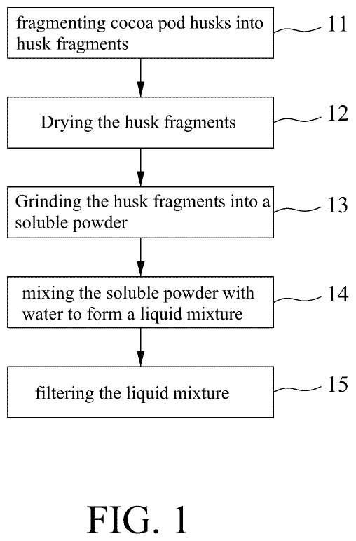

Referring to FIG. 1, a first embodiment of the disclosure is a method for making a cocoa pod husk-containing hardening-retarder from cocoa pod husks. The method includes steps 11 to 15.

Step 11 is a preparation step for preparing cocoa pod husks by fragmenting the cocoa pod husks. Cocoa pod husks may be obtained by removing cocoa beans and cocoa pulp from cocoa pods. The cocoa pod husks may be readily obtained since a large amount of cocoa pod husks are produced as waste by-product from the cocoa processing industries such as the chocolate industry. In step 11, the cocoa pod husks are prepared by fragmenting the cocoa pod husks to form husk fragments that have a size suitable for feeding into a subsequent processing machine. The cocoa pod husks may be fragmented by the crushing and or cutting of the same.

It should be noted that the cocoa pod husks used in the present disclosure has no edible value. In addition to fiber, the cocoa pod husks contain two triterpenes such as betulinic acid, and alphitolic acid, vanillic acid, succinic acid, luteolin, two ligans such as 4-ketopinoresinol, syringaresinol, and β-sitosterol.

The step 12 involves drying the husk fragments under a temperature that ranges from 95° C. to 105° C. In some embodiments, the husk fragments are dried for a time period that ranges from 20 to 30 hours. In other embodiments, the husk fragments may be dried under a temperature of 100° C. and dried for a time period of 24 hours. This step is to reduce the amount of moisture in the husk fragments without overheating the husk fragments so as to prevent damaging of its chemical composition.

The step 13 involves grinding the husk fragments which have been dried into a soluble powder. The soluble powder is ground to a particle size of under 0.075 mm. The particle size is chosen so as to enable the soluble powder to dissolve in a solvent and to release organic acidic components from the soluble powder.

The step 14 involves mixing the soluble powder with water to form a liquid mixture. The liquid mixture contains from 20% to 40% of the soluble powder by weight and 60% to 80% of water by weight, based on 100% of the liquid mixture by weight. In some embodiments, purified water is used for mixing with the soluble powder. In some embodiments, the step 14 of mixing is carried out by stirring the soluble powder in water under room temperature for a period that ranges from 1 to 3 hours. This ensures that the soluble powder is completely dissolved in the water, and that the organic acidic substances in the soluble powder are extracted to reach a certain desired concentration level. In this embodiment, the liquid mixture contains 30% of the soluble powder by weight and 70% purified water by weight, and is stirred for 1.5 hours so as to efficiently extract the organic acidic substances in a sufficient amount.

The step 15 involves filtering the liquid mixture with a filter having a pore size that ranges from 5 microns to 20 microns. In this step suspended particles in the liquid mixture that are not dissolved and that are larger than 20 microns will be filtered out and the cocoa pod husk-containing hardening-retarder will be obtained.

In the method for making the cocoa pod husk-containing hardening-retarder according to the present disclosure, the drying of the husk fragments in step 12, the grinding of the husk fragments into the soluble powder in step 13, and the mixing of the soluble powder with water to form the liquid mixture in step 14 allows an efficient extraction of the water soluble organic acidic substances. The organic acidic substances thus extracted are able to provide an adsorption effect on cement or concrete particle surfaces that retard cement hardening because the organic acidic substances have higher activity to the particle surfaces.

A second embodiment of the disclosure is a cocoa pod husk-containing hardening-retarder made according to the method of the first embodiment.

TABLE 1

| | | Sample (B) |
|---|---|---|
| | | cocoa husk-containing |
| | Sample (A) | hardening-retarder + |
| | Portland I cement | Portland I cement |
| Initial setting (min) | 171 | 275 |
| Final setting (min) | 271 | 385 |

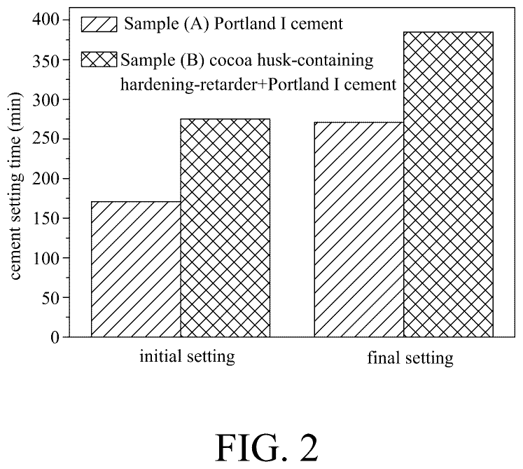

Referring to FIG. 2, Sample (B) consists of the cocoa pod husk-containing hardening-retarder and Portland I cement, and Sample (A) consists of only Portland I cement. The cocoa pod husk-containing hardening-retarder in Sample (B) substitutes for a portion of the Portland I cement used in Sample (A), specifically, 0.1 weight % to 5.0 weight % of Portland I cement (Portland cement type 1) used in Sample (A). Tests for time of setting of hydraulic cement were conducted via a method using a Vicat needle according to CNS786 (Chinese National Standard, General No. CNS786) for Sample (A) and Sample (B). Sample (A) is pure Portland I cement, and Sample (B) is Portland I cement with cocoa pod husk-containing hardening-retarder. The results are shown in FIG. 2 and Table 1. It is observable from Table 1 that the initial setting time of sample (B) is retarded by 60.82% in comparison of the initial setting time of sample (A), and the final setting time of sample (B) is retarded by 42.01% when in comparison to sample (A). The above results show that the cocoa pod husk-containing hardening-retarder according to the present disclosure may act as an effective retarder for Portland cement.

In summary of the above, the method of making the cocoa pod husk-containing hardening-retarder according to the present disclosure is able to utilize non-edible waste products of cocoa plants. After processing according to the method of the disclosure the cocoa pod husk-containing hardening-retarder thus obtained was shown to be effective in retarding Portland cement setting. Therefore, the method according to the present disclosure creates a new field of opportunity to generate revenue from discarded cocoa pod husks.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for making a cocoa pod husk-containing hardening-retarder from cocoa pod husks comprising:
fragmenting cocoa pod husks into husk fragments;
drying the husk fragments under a temperature that ranges from 95° C. to 105° C.;
grinding the husk fragments which have been dried into a soluble powder;
mixing the soluble powder with water to form a liquid mixture, wherein the liquid mixture contains from 20% to 40% by weight of the soluble powder and 60% to 80% of water based on 100% by weight of the liquid mixture; and
filtering the liquid mixture with a filter having a pore size that ranges from 5 microns to 20 microns to obtain the cocoa pod husk-containing hardening-retarder.

2. The method of making the cocoa pod husk-containing hardening-retarder as claimed in claim 1, wherein in the step of drying the husk fragments, the husk fragments are dried for a time period that ranges from 20 to 30 hours.

3. The method as claimed in claim 2, wherein in the step of mixing the soluble powder with water includes stirring the soluble powder in water under room temperature for a period that ranges from 1 to 3 hours.

4. A cocoa pod husk-containing hardening-retarder made according to the method of claim 1.
